(19) United States
(12) Patent Application Publication
(10) Pub. No.: US 2026/0204950 A1
(43) Pub. Date: Jul. 16, 2026

(54) INTERMITTENT POWER PROFILE FOR WIRELESS POWER TRANSFER

(71) Applicant: Apple Inc., Cupertino, CA (US)

(72) Inventors: Adam L Schwartz, Redwood City, CA (US); Ankan De, San Jose, CA (US); Lixin Shi, San Jose, CA (US); Srinivasa V. Thirumalai Ananthan Pillai, Santa Clara, CA (US); Jizhen Fu, San Jose, CA (US)

(21) Appl. No.: 19/413,446

(22) Filed: Dec. 9, 2025

Related U.S. Application Data
(60) Provisional application No. 63/745,009, filed on Jan. 14, 2025.

(51) Int. Cl. H02J 50/10; H02J 50/80

(52) U.S. Cl. CPC H02J 50/10; H02J 50/80

(57) ABSTRACT

Operating a wireless power transfer system according to a plurality of wireless power transfer profiles, the plurality of wireless power transfer profiles including an intermittent power profile and at least one additional profile can include: establishing wireless power transfer in accordance with the at least one additional profile; determining by at least one of the wireless power transmitter or the wireless power receiver in the system, whether a higher efficiency is possible by operating according to the intermittent power profile; and initiating by at least one of the devices a transition to the intermittent power profile; wherein the intermittent power profile comprises alternating the wireless power transfer system between an active state and a quiescent state.

### BACKGROUND

Wireless power transfer is used in various electronic devices. For example, smart phones, tablet computers, smart watches, wireless earphones, styluses, etc. may employ wireless power transfer to facilitate charging of batteries within the devices and/or to power the devices during operation.

### SUMMARY

A method of operating a wireless power transfer system including a wireless power transmitter and a wireless power receiver according to a plurality of wireless power transfer profiles, the plurality of wireless power transfer profiles including an intermittent power profile and at least one additional profile can include: establishing wireless power transfer in accordance with the at least one additional profile; determining by at least one of the wireless power transmitter or the wireless power receiver whether a higher efficiency is possible by operating according to the intermittent power profile; and initiating by at least one of the wireless power transmitter or the wireless power receiver a transition to the intermittent power profile; wherein the intermittent power profile comprises alternating the wireless power transfer system between an active state and a quiescent state according to a macro duty cycle representing a relationship between a duration of the active state and a duration of the quiescent state within a respective period of the macro duty cycle. The method can further include determining whether the wireless power transfer system is operating at a predetermined frequency at which the intermittent power profile is permitted.

Determining whether a higher efficiency is possible by operating according to the intermittent power profile and initiating a transition to the intermittent power profile can be performed by the wireless power receiver. The wireless power receiver can request an increase in the macro duty cycle responsive to a determination that more power is required and can request a decrease in the macro duty cycle responsive to a determination that less power is required.

The at least one additional profile can include at least one of a Nominal Power Profile and a Light Load Profile defined by a Qi wireless power transfer standard. At least one of the wireless power transmitter or the wireless power receiver can: responsive to determining that the macro duty cycle is at a minimum macro duty cycle value, initiate a transition to a Light Load Profile defined by a Qi wireless power transfer standard; or responsive to determining that the macro duty cycle is at a maximum macro duty cycle value, initiate a transition to a Nominal Power Profile defined by a Qi wireless power transfer standard.

A wireless power receiver can include: a wireless power receiving coil magnetically couplable to a wireless power transmitting coil of a wireless power transmitter so as to allow the wireless power transmitting coil to transfer power to the wireless power receiver by inducing an alternating current in the wireless power receiving coil; a rectifier coupled to the wireless power receiving coil that rectifies the alternating current induced in the wireless power receiving coil to produce a rectifier output voltage; and wireless power receiver control circuitry coupled to the wireless power receiving coil and the rectifier that operates to vary the rectifier output voltage according to one or more wireless power transfer profiles; wherein the one or more wireless power transfer profiles include an intermittent power profile in which the rectifier alternates between an active state and a quiescent state according to a macro duty cycle representing a relationship between a duration of the active state and a duration of the quiescent state within a respective period of the macro duty cycle.

The wireless power receiver control circuitry can alternate between the active state and the quiescent state according to the macro duty cycle. The one or more wireless power transfer profiles can include at least one additional profile selected from the group consisting of a Nominal Power Profile and a Light Load Profile defined by a Qi wireless power transfer standard. The wireless power receiver control circuitry can select the intermittent power profile responsive to a determination that a present power level can be delivered with higher efficiency operating according to the intermittent power profile. The determination that a present power level can be delivered with higher efficiency operating according to the intermittent power profile can be made by the wireless power receiver control circuitry responsive to receiving an input power level from the wireless power transmitter. The determination that a present power level can be delivered with higher efficiency operating according to the intermittent power profile can be made by the wireless power transmitter responsive to receiving an output power level from the wireless power receiver. The wireless power receiver control circuitry can request an increase in the macro duty cycle responsive to a determination that more power is required and can request a decrease in the macro duty cycle responsive to a determination that less power is required.

At least one of the wireless power transmitter or the wireless power receiver can: responsive to determining that the macro duty cycle is at a minimum macro duty cycle value, initiate a transition to a Light Load Profile defined by a Qi wireless power transfer standard; or responsive to determining that the macro duty cycle is at a maximum macro duty cycle value, initiate a transition to a Nominal Power Profile defined by a Qi wireless power transfer standard. The determination that a present power level can be delivered with higher efficiency operating according to the intermittent power profile can be supplemented or replaced with a determination based on at least one of thermal conditions of the wireless power receiver or interoperability considerations.

A wireless power transmitter can include: a wireless power transmitting coil magnetically couplable to a wireless power receiving coil of a wireless power receiver so as to allow the wireless power transmitting coil to transfer power to the wireless power receiver by inducing an alternating current in the wireless power receiving coil; an inverter coupled to the wireless power receiving coil that produces an alternating current induced in the wireless power receiving coil to allow a rectifier of the wireless power receiver to produce a rectifier output voltage; and wireless power transmitter control circuitry coupled to the wireless power transmitting coil and the inverter that operates to allow the wireless power transmitter to vary the rectifier output voltage according to one or more wireless power transfer profiles; wherein the one or more wireless power transfer profiles include an intermittent power profile in which the inverter alternates between an active state and a quiescent state according to a macro duty cycle representing a relationship between a duration of the active state and a duration of the quiescent state within a respective period of the macro duty cycle.

The wireless power transmitter control circuitry can alternate between the active state and the quiescent state according to the macro duty cycle. The one or more wireless power transfer profiles can include at least one additional profile selected from the group consisting of a Nominal Power Profile and a Light Load Profile defined by a Qi wireless power transfer standard. The wireless power transmitter control circuitry can select the intermittent power profile responsive to a determination that a present power level can be delivered with higher efficiency operating according to the intermittent power profile. The determination that a present power level can be delivered with higher efficiency operating according to the intermittent power profile can be made by the wireless power receiver responsive to receiving an input power level from the wireless power transmitter. The determination that a present power level can be delivered with higher efficiency operating according to the intermittent power profile can be made by the wireless power transmitter control circuitry responsive to receiving an output power level from the wireless power receiver. The wireless power transmitter control circuitry can increase the macro duty cycle to increase power delivered to the wireless power receiver responsive to a request received from the wireless power receiver and can decrease the macro duty cycle to decrease power delivered to the wireless power receiver responsive to a request received from the wireless power receiver.

At least one of the wireless power transmitter or the wireless power receiver can: responsive to determining that the macro duty cycle is at a minimum macro duty cycle value, initiate a transition to a Light Load Profile defined by a Qi wireless power transfer standard; or, responsive to determining that the macro duty cycle is at a maximum macro duty cycle value, initiate a transition to a Nominal Power Profile defined by a Qi wireless power transfer standard. The determination that a present power level can be delivered with higher efficiency operating according to the intermittent power profile can be supplemented or replaced with a determination based on at least one of thermal conditions of the wireless power receiver or interoperability considerations.

### BRIEF DESCRIPTION OF THE DRAWINGS

FIG. 1 illustrates a simplified block diagram of a wireless power transfer system.

FIG. 2 illustrates plots of rectifier power versus rectifier voltage for various conditions in various wireless power transfer protocols.

FIG. 3 illustrates a plot of average power versus efficiency for various wireless power transfer protocols.

FIG. 4 illustrates a simplified wireless power transmitter operation diagram for an intermittent power profile with macro duty cycle control for wireless power transfer.

FIG. 5 illustrates a flowchart of wireless power transfer operation in a nominal power profile and an intermittent power profile.

FIG. 6 illustrates a flowchart of wireless power transfer operation in a low power profile and an intermittent power profile.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose. Any trademarks referenced herein are intended to only to identify examples and are property of their respective owners.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

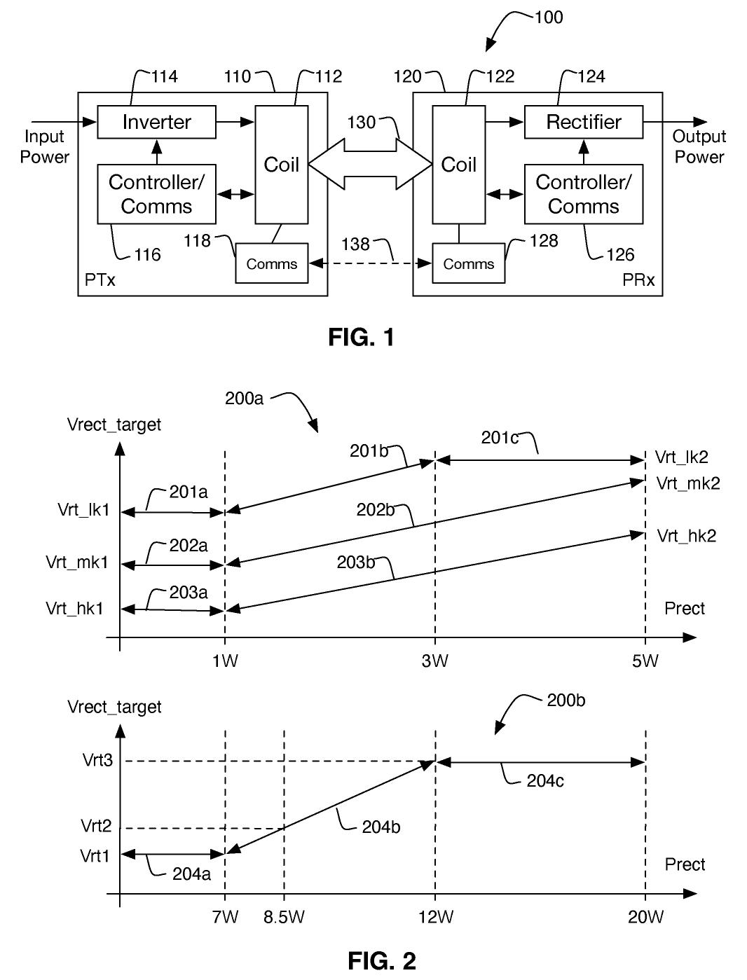

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

Increased use of wireless power transfer for applications requiring various power levels, operating voltages, etc. has led the development of wireless power transfer profiles to accommodate different operating situations. As but one example, versions of the Qi wireless power transfer standards promulgated by the Wireless Power Consortium includes two power profiles. A Nominal Power Profile (NPP) can be used to provide high operating efficiency at nominal load levels by operating the wireless power transfer system at relatively higher voltages for Vrect, i.e., the output voltage of rectifier 124 in wireless power receiver 120. A Light Load Profile (LLP) can be used to provide high operating efficiency at lower load levels by operating the wireless power transfer systems at lower Vrect voltages. Various aspects of these two exemplary wireless power transfer profiles are illustrated with reference to FIG. 2.

FIG. 2 illustrates plots of rectifier power versus rectifier voltage for various conditions in various wireless power transfer protocols. More specifically, plot 200a illustrates various traces for a light load profile with relatively lower rectifier output voltages (Vrect). Different traces, 201, 202, 203, correspond to different rectified voltage (Vrect_target) targets based on different coupling conditions, such as a low coupling condition (curve 201), a medium coupling condition (curve 202), and a high coupling condition (curve 203). The Vrect_target values for different coupling conditions enable optimization of the efficiency of the power transfer. The voltages, coupling coefficients, and power levels described below are merely examples, and the same operating principles may be employed for differing voltages, coupling coefficients, and/or power levels. Illustrated curve 201, including segments 201a, 201b, and 201c can correspond to light load operation with a relatively lower coupling coefficient (e.g., k=0.6). For power levels under 1W, a Vrect_target Vrt_lk1 (e.g., 9.6V) can be used, corresponding to curve segment 201a. For power levels between 1W and 3W, a Vrect_target increasing proportionally with load from Vrt_lk1 to Vrt_lk2 (e.g., 9.6V to 12.5V) can be used, corresponding to curve segment 201b. For power levels above 5W, a target voltage of Vrt_lk2 (e.g., 12.5V) can be used (although this can correspond to a load level at which the nominal power profile, discussed in greater detail below can be used).

Similarly, curve 202, including segments 202a and 202b can correspond to light load operation with a relatively higher coupling coefficient (e.g., k=0.75) as compared to curve 201, i.e., a medium coupling condition. For power levels under 1W, a rectifier target voltage (Vrect_target) of Vrt_mk1 (e.g., 7.7V) can be used, corresponding to curve segment 202a. For power levels above 1W increasing to 5W, a rectifier target voltage (Vrect_target) increasing proportionally with load from Vrt_mk1 to Vrt_mk2 (e.g., 7.7V to 11.7V) can be used, corresponding to curve segment 202b. For power levels above 5W, a target voltage of Vrt_mk2 (e.g., 11.7V) can be used (although this can correspond to a load level at which the nominal power profile, discussed in greater detail below can be used. Finally, curve 203, including segments 203a and 203b can correspond to light load operation with a still higher coupling coefficient (e.g., k>0.89). For power levels under 1W, a rectifier target voltage (Vrect_target) of Vrt_hk1 (e.g., 6.5V) can be used, corresponding to curve segment 203a. For power levels between 1W and 5W, a rectifier target voltage (Vrect_target) increasing proportionally with load from Vrt_hk1 to Vrt_hk2 (e.g., 6.4V to 9.8V) can be used, corresponding to curve segment 203b. For power levels above 5W, a target voltage of Vrt_hk2 (e.g., 9.8V) can be used (although this can correspond to a load level at which the nominal power profile, discussed in greater detail below can be used). As noted above, the example power levels, coupling coefficients, and voltages described above are merely exemplary, and the principles described above can be applied to any suitable range of these values.

The light load profile (LLP) can be summarized by operation at lower target rectifier voltages when operating at relatively lower power levels. In some cases, these lower power levels can be below a threshold level, such as 5W, although other threshold levels could be used. In some cases, the lower target rectifier voltage can be a constant voltage below a first threshold. In some cases, the lower rectifier target voltage can increase proportionally to load between the first threshold and a second threshold. In some cases, the lower rectifier target voltage can be a constant value above the second threshold, which can correspond to a point at which a different power profile (such as a nominal power profile) can be used. Lower rectifier target voltage, in this context, refers to a rectifier target voltage that is lower than a rectifier target voltage in another wireless power profile, such as a nominal power profile discussed in greater detail below.

Plot 200b illustrates a rectifier target voltage versus load trace for a nominal power profile (NPP) with relatively higher rectifier output voltages (Vrect) as compared to the light load profile discussed above. Again, the illustrated voltages and power levels are merely examples, and the same operating principles may be employed for differing voltages and/or power levels. Illustrated curve 204, including segments 204a, 204b, and 204c can correspond to nominal operation. For power levels under 7W, a rectifier target voltage (Vrect_target) of Vrt1 (e.g., 12.5V) can be used, corresponding to curve segment 204a. The regime below 7W, or another suitable threshold, can include the light load regime as described above. Thus, the higher rectifier target voltage of Vrt1 (e.g., 12.5V) may in turn decrease further with further decreased load, e.g., in accordance with a light load profile as described above. For power levels between 7W and about 12W, the rectifier target voltage (Vrect_target) can increase proportionally with load from Vrt1 to Vrt3 (e.g., 12.5V to 18V), corresponding to curve segment 204b. This might result in a rectifier target voltage (Vrect_target) value of Vrt2 (e.g., 14V) at a load of 8W, as one example. For power levels above about 12W, a target voltage of Vrt3 (e.g., 18V) can be used, corresponding to curve segment 204c. As above, the example power levels, coupling coefficients, and voltages described above are merely exemplary, and the principles described above can be applied to any suitable range of these values.

NPP can be summarized by operation at higher target rectifier voltages when operating at relatively higher power levels. In some cases, these higher power levels can be above a threshold level, such as 5W, although other threshold levels could be used. In some cases, the higher target rectifier voltage can be a constant voltage below a third threshold. In some cases, the lower rectifier target voltage can increase proportionally to load between the third threshold and a fourth threshold. In some cases, the lower rectifier target voltage can be a constant value above the fourth threshold. Higher rectifier target voltage, in this context, refers to a rectifier target voltage that is higher than a rectifier target voltage in another wireless power profile, such as a light load profile discussed in greater detail above.

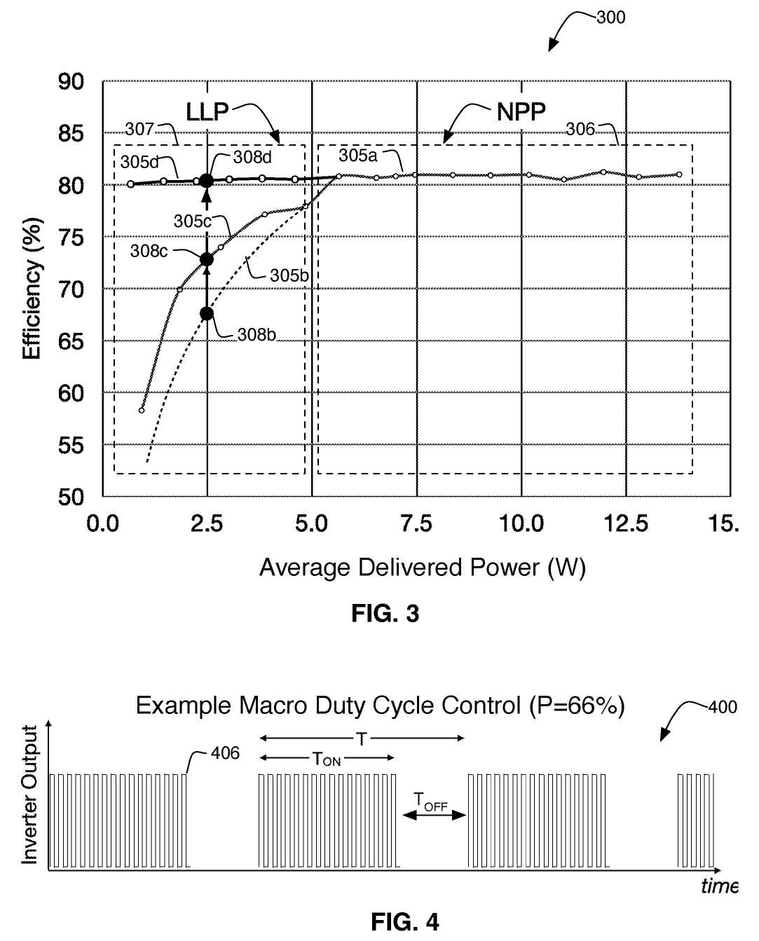

FIG. 3 illustrates a plot 300 of average power versus efficiency for various wireless power transfer protocols. The illustrated plot is an example for one embodiment, and the specific values of power level and efficiency could vary from one situation to another. However, the general trends illustrated and described below are applicable to all such situations. Segment 305a corresponds to operation according to a nominal power profile (NPP) such as the nominal power profile described above. The region in which a nominal power profile is used can be illustrated by box 306, corresponding to operating power levels above about 5W, although, as noted above, other thresholds/transitions between the nominal power profile and another power profile could be used. Segment 305b corresponds to operation according to a light load profile (LLP) such as the light load profile described above. The region in which a light load profile is used can be illustrated by box 307, corresponding to operating power levels below about 5W, although, as noted above, other thresholds/transitions between the nominal power profile and another power profile could be used. As illustrated in FIG. 3, wireless power transfer efficiency can significantly decrease when using the nominal power profile (NPP) below a certain threshold, e.g., 5W (corresponding to curve 305b). Some portions of this efficiency decrease are inevitable because of fixed losses associated with the wireless power transfer system, which do not decrease with load, and thus become a larger portion of the total power at lower load conditions. In any case, operating according to the light load profile (LLP) below the threshold (e.g., 5W) can allow for higher efficiency, as illustrated by curve 305c. As one example, operating at a load of 2.5W can correspond to an efficiency of about 68% (point 308b) when operating using the nominal power profile (NPP), while the same load can be merely exemplary, powered with about 73% efficiency (point 308c) when operating according to the light load profile (LLP).

For some applications or operating conditions, it may be desirable to employ an alternative profile for at least a portion of such a lower power regime that can allow for increased operating efficiency. In one case, such an alternative profile can be an intermittent power profile (IPP) employing macro duty cycle control of the wireless power transfer system, including the inverter of the PTx and the rectifier of the PRx. The intermittent power profile is described in greater detail below. However, as a preview of the benefits of an intermittent power profile, efficiency curve segment 305d illustrates how such an intermittent power profile can have a higher operating efficiency than a light load profile (LLP) or nominal power profile (NPP) as described above when operating in the light load regime enclosed in box 307. As one non-limiting example, operating at an average power of 2.5W might result in an efficiency of about 80% (operating point 308d) when using an intermittent power profile (IPP) as compared to the less efficient operating points 308c or 308b, corresponding to the light load profile (LLP) and nominal power profile (NPP) discussed above.

FIG. 4 illustrates a simplified wireless power transmitter operation diagram 400 for an intermittent power profile with macro duty cycle control for wireless power transfer. More specifically, FIG. 4 illustrates inverter operation in the form of inverter pulses 406. Intermittent power profile (IPP) refers to a power profile in which the wireless power transfer system—including the inverter (also potentially including PTx control circuitry 116) and the rectifier (also potentially including the PRx control circuitry 126) are intermittently placed in a quiescent state according to a macro duty cycle. In this quiescent state, neither the inverter 114 nor the rectifier 124 is switching, thus reducing switching losses associated with their operation. Moreover, because neither the inverter 114 nor the rectifier 124 is in operation, current flow is reduced, thereby also potentially reducing conduction losses. Additionally, because neither inverter 114 nor rectifier 124 is in operation, their associated control circuitry (e.g. PTx control circuitry 116 and PRx control circuitry 126) can also operate in a lower power state, such as one in which their programmable controllers operate at a lower frequency, when such controllers intermittently sleep, or other low power states. This can provide for still further power reduction, in turn increasing overall operating efficiency. The respective PTx and PRx devices and their associated control circuitry can enter and exit the quiescent state based on timers, interrupts, or other suitable triggers.

The wireless power transfer system thus transitions between a normal operating state (e.g., using a nominal power profile) and a quiescent state according to a macro duty cycle. The macro duty cycle is defined with reference to a total time period T that is the sum of the on-time Ton and the off-time Toff. The normal operating state corresponds to on time Ton during which the inverter is in operation (as depicted in FIG. 4), and the quiescent state corresponds to off time Toff during which the inverter is not in operation (as depicted in FIG. 4). During the on time, the rectifier is also in operation, optionally along with the respective control circuitry for PTx and PRx, and during the off time, the rectifier is also not in operation, along with the respective control circuitry. The macro duty cycle is thus the ratio of Ton to T, both of which, for example, may be on the order of seconds or tens of seconds. The macro duty cycle may be on the order of the thermal time constant(s) of the system. For example, if the inverter is operating at 360kHz and the system thermal time constant is around 10s, then the on/off period of the duty-cycle control may be around 1s (or 360,000 inverter cycles).

The macro duty cycle is thus distinct from conventional duty cycle control, e.g., duty cycle control of the inverter. According to conventional duty cycle control, the “micro” duty cycle of the inverter switching devices can be varied at the operating frequency of the inverter, which can be on the order of kHz, hundreds of kHz or higher. That is, the individual inverter pulses can be lengthened or shortened as a ratio of the inverter switching period. Thus, the “micro” duty cycle would correspond to time periods on the order of milliseconds, microseconds, or less. Inverter pulses 406, illustrated in FIG. 4, may themselves have a varying duty cycle caused by conventional cycle-by-cycle duty cycle control of the inverter switching devices at the inverter switching frequency, i.e., “micro” duty cycle control. This is distinct from “macro” duty cycle control, in which the inverter operates intermittently according to the macro duty cycle, as described herein. Importantly, variation of this “micro” duty cycle would also result in an increase or decrease in the output voltage of the inverter. Conversely, changes in the macro duty cycle corresponding to the intermittent power profile do not substantially vary the inverter output voltage (while in operation), and thus do not change the corresponding rectifier voltage Vrect. Thus, the operating voltages in the intermittent power profile can correspond to the level associated with the nominal power profile, e.g., the example values described above with reference to FIG. 2 or other suitable voltage values.

In some embodiments, the total time period T can range between a minimum value Tmin and a maximum value Tmax. Minimum period Tmin can be selected to account for the time necessary to ramp up inverter voltage when switching resumes at the beginning of the Ton interval. That is, when the inverter (and rectifier) stop switching and pause during the quiescent period the output voltage of the inverter may decay. Once switching resumes, it can take a short recovery period, e.g., on the order of milliseconds, for the voltage to recover to the operating voltage value corresponding to the power being delivered (see, e.g., FIG. 2). If the total period T is too short, then this recovery period can become so large a fraction of the total time period that operation of the wireless power transfer system can be adversely affected. For example, a sufficient fraction of the total period T (or on time Ton) can be spent on ramping voltage such that operating efficiency is actually lower than it would be with the low load profile or other operating mode.

Maximum period Tmax can be selected based on thermal constraints of the system and/or to prevent system brown-out if the system load can deplete the battery during Toff. This situation might occur, for example, if the receiver is already hot and therefore limiting the input power despite having a low battery state of charge. As one example, the intermittent power profile can be used to provide increased operating efficiency in a case where the total wireless power transfer is reduced because of thermal constraints in the system, such as with the PRx device or the PTx device. One example of such a condition might be when a PRx device such as a smartphone or other personal electronic device is in use, such that the display system, processing system, network system, etc. are consuming sufficient power and generating sufficient heat that the amount of power transferred wirelessly is reduced to remain within some thermal limit. In the case of personal electronic devices, the thermal time constant might be on the order of 10s, although other values are also possible. There are other conditions, including conditions unrelated to thermal constraints where an intermittent power profile as described herein might be used. However, for many applications, a total time period on the order of 1s, 5s, 10s, 20s, 30s, 60s, 90s, 100s, 120s, etc. might also be used. It is anticipated that the macro duty cycle would thus have a total time period T of 1s or greater.

As described in greater detail below, efficiency considerations can trigger a transition from a nominal power profile (NPP) (or any other wireless power transfer profile) to the intermittent power profile (IPP). For example, either the PRx or the PTx could determine that a present power level could be delivered with higher efficiency by transitioning to the intermittent power profile. Such a determination could be based on either information stored in the PRx or PTx device a priori, such as based on analysis performed during a design phase, with the information being stored in the device at manufacture. Similarly, such stored information could be provided or updated at a later time, such as with a software or firmware update. Additionally, or alternatively, either the PTx and/or PRx device could monitor the transferred power and the present operating efficiency, initiating a transfer to the intermittent power profile when the efficiency decreases below some threshold corresponding to a level at which the intermittent power profile would be more efficient for the given power level.

Conversely, operating conditions may suggest that it is appropriate to transition from the intermittent power profile to another power profile, such as the light load profile or the nominal power profile. For example, there may be minimum or maximum macro duty cycle values below or above which the intermittent power profile is less desirable. This could be for efficiency, stability, voltage regulation, or other reasons. In such cases reaching such a macro duty cycle limit can trigger a transition to another wireless power transfer profile, such as a light load profile, nominal power profile, or other power profile.

In some cases, considerations other than or in addition to operating efficiency could be used to trigger a transition to or from the intermittent power profile. For example, in some power profiles, operating frequency may be adjusted to regulate power delivered across the wireless link. In some cases, there may be operating frequencies that are preferably avoided due to interoperability or interference concerns. In such cases, when the operating frequency approaches the frequencies preferably avoided, a transition to the intermittent power profile could be initiated so as to avoid operating at the frequencies preferably avoided. Likewise, as suggested above, thermal constraints may also motivate a transition to the intermittent power profile when constant operation (e.g., in a nominal power profile) would cause thermal condition beyond a certain limit, switching to an intermittent mode of operation can reduce the thermal load imposed on the device (either PRx or PTx) while still allowing for increased efficiency relative to a low load profile or other operating profile.

In any case, control of the wireless power transfer profile and the transitions between such profiles can be controlled by the PTx, the PRx, or by both devices acting in concert. In some applications, one device (e.g., the PRx) may control the transition and direct the other (e.g., the PTx) to transition profiles. In other cases, the reverse may be true. In still other cases, the transition may be a negotiated one, with each device providing information and/or preferences to the other. In any of these cases, communication between the PTx and PRx and vice versa may be according to standardized in-band communication protocols, such as those specified in the Qi standards, or may be according to one or more proprietary communication protocols. Additionally, in some cases, out of band communications could be used. Such communications, however implemented, may involve the use of PTx control and communication circuitry 116/118 and PRx control and communication circuitry 126/128, collectively described as control circuitry herein.

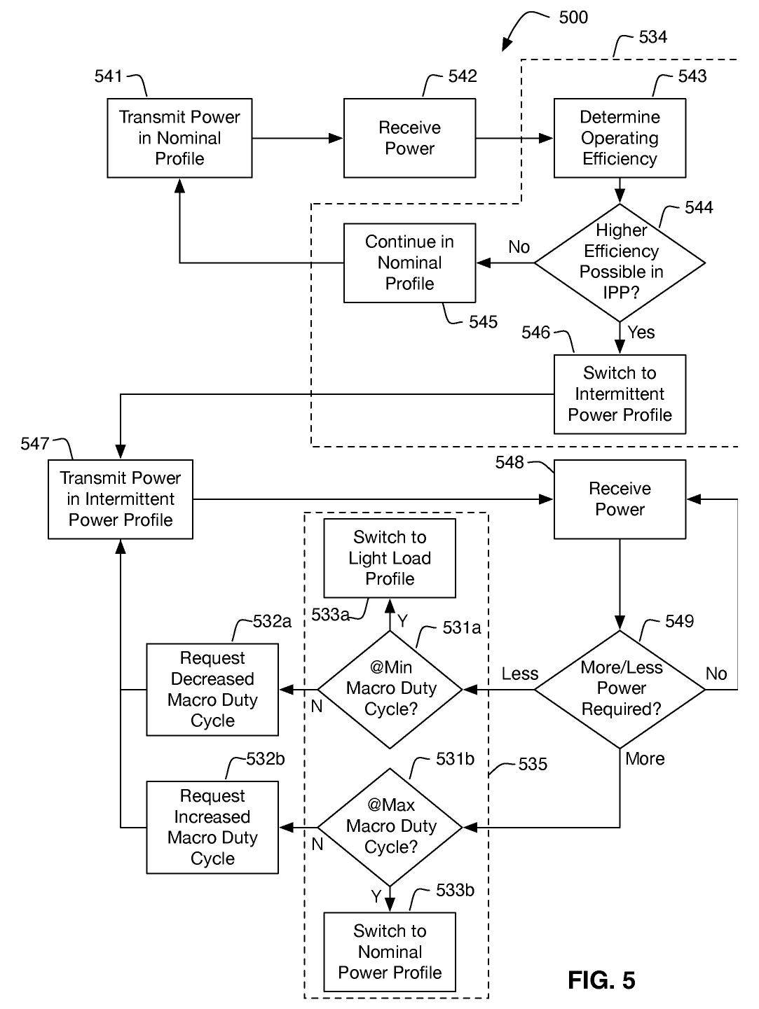

FIG. 5 illustrates a flowchart 500 of wireless power transfer operation in a nominal power profile and an intermittent power profile. As described below, operations performed by PTx and/or PRx may be performed by the control circuitry of the respective device, potentially operating in conjunction with other components of the respective devices, including the communication circuitry, the wireless power transfer circuitry, etc. The wireless power transfer operation can begin with power transmission in a Nominal Power Profile (NPP) (block 541) as described above. This profile is used as an example, and the wireless power transfer can take place according to any applicable power profile. Power transmission can be performed by a PTx, as described above.

Correspondingly, a PRx can receive power (block 542). As described above, during the power transfer either or both of the PTx and PRx can initiate a transition from the NPP (or other profile) to an intermittent power profile as described above. The operations corresponding to such a transition that can be performed by either/both devices are contained within block 534. Beginning with block 543, the operating efficiency can be determined. This determination can be made by either the PTx or PRx and may be in accordance with a determination whether the wireless power transfer system is operating at a predetermined frequency at which use of the Nominal Power Profile (NPP) or intermittent power profile (IPP) are permitted. The operation may require one device to transfer a relevant power level to the other. For example, operating efficiency can be expressed as the ratio of output power (i.e., Prect or the power delivered by the rectifier of the PRx) to input power (i.e., the input power or inverter power delivered by the inverter of the PTx). Thus, one device other the other may communicate its power level to the other for use in the efficiency determination.

In block 544, either device can determine whether a higher operating efficiency would be possible in the intermittent power profile mode. If not, then the system can continue operating with the present wireless power transfer profile (e.g., the Nominal Power Profile) in block 545. Otherwise, the system can switch to the intermittent power profile in block 546. As described above, the higher efficiency determination can be supplemented or replaced by other consideration, such as thermal load, operating frequency, etc. In any case, the foregoing operations contained within block 534 can be performed by the PRx, the PTx, or by the two devices acting in concert, such as by negotiating the power transfer profile. Regardless of which device(s) are performing the operations, communication between the devices may be employed as appropriate to provide data to inform the determinations, instruction to initiate a transfer, requests to initiate a transfer, acknowledgements of any of the foregoing, etc.

With the intermittent power profile initiated, the PTx can transmit power according to the intermittent profile (block 547) as described above. Correspondingly, the PRx can receive power (block 548). The receiver can also determine whether more or less power is required (block 549). If not, power transfer can continue. If less power is required, the wireless power receiver can determine whether the system is already operating at its minimum macro duty cycle (block 531a). If so, then the system can transition to another power profile, such as a light load profile (block 533a) as described above. Otherwise, the wireless power receiver can send a request to the PTx to decrease the macro duty cycle (block 532b), thereby reducing the power delivered to the PRx. If more power is required, the wireless power receiver can determine whether the system is already operating at its maximum macro duty cycle (block 531b). If so, then the system can transition to another power profile, such as a nominal power profile (block 533b) as described above. Otherwise, the wireless power receiver can send a request to the PTx do increase the macro duty cycle (block 532b), thereby increasing the power delivered to the PRx.

In some cases, the minimum duty cycle could be zero, corresponding to suspended or cloaked operation. In other cases, the minimum duty cycle could be some non-zero minimum value determined by any appropriate operating condition or constraint. Similarly, the maximum macro duty cycle could be 100%, corresponding to the nominal power profile as described above. In other cases, the maximum duty cycle could be some value less than 100% determined by any appropriate operating condition or constraint. Additionally, the operations inside block 535 could be performed by the PRx, the PTx, and/or by both devices acting in concert, such as by negotiation. If the PTx were to make the determination that a minimum or maximum macro duty cycle had been reached, then this could take place after the corresponding request was received from the PRx. Thus, the order of certain blocks illustrated in the flowchart of FIG. 5 could be different. In general, unless expressly required or necessitated by context, the various operations depicted could take place in a different order.

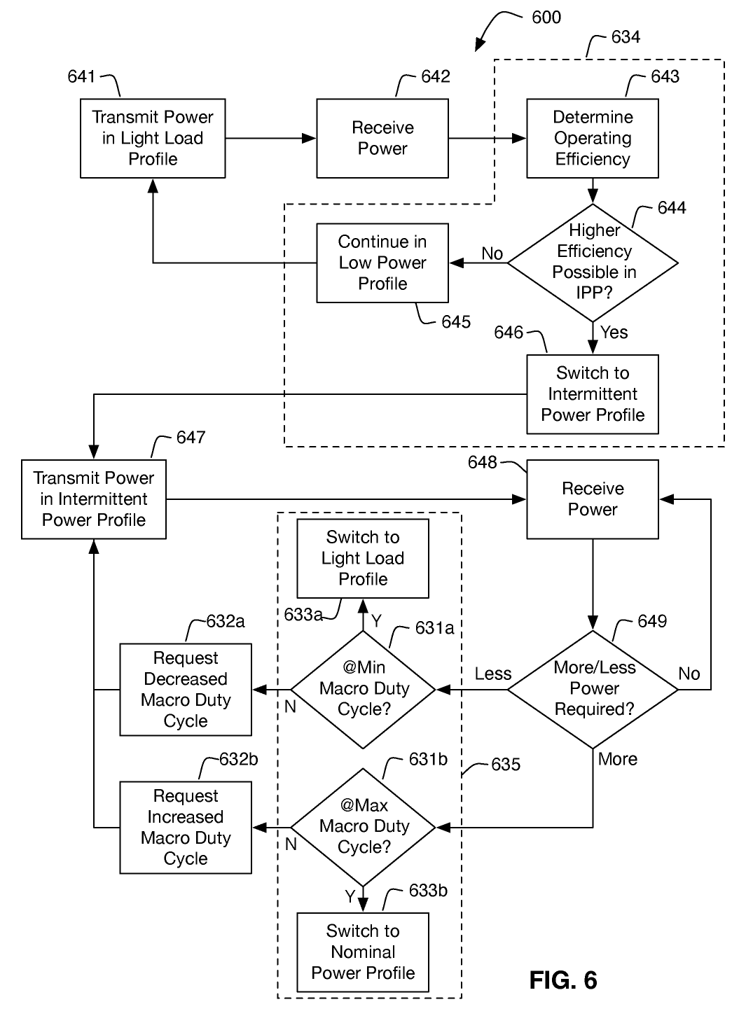

FIG. 6 illustrates a flowchart 600 of wireless power transfer operation in a light load profile and an intermittent power profile. As described below, operations performed by PTx and/or PRx may be performed by the control circuitry of the respective device, potentially operating in conjunction with other components of the respective devices, including the communication circuitry, the wireless power transfer circuitry, etc. The wireless power transfer operation can begin with power transmission in a Light Load Profile (LLP) (block 641) as described above. This profile is used as an example, and the wireless power transfer can take place according to any applicable power profile. Power transmission can be performed by a PTx, as described above.

Correspondingly, a PRx can receive power (block 642). As described above, during the power transfer either or both of the PTx and PRx can initiate a transition from the LLP (or other profile) to an intermittent power profile as described above. The operations corresponding to such a transition that can be performed by either/both devices are contained within block 634. Beginning with block 643, the operating efficiency can be determined. This determination can be made by either the PTx or PRx and may be in accordance with a determination whether the wireless power transfer system is operating at a predetermined frequency at which use of the Nominal Power Profile (NPP) or intermittent power profile (IPP) are permitted. The operation may require one device to transfer a relevant power level to the other. For example, operating efficiency can be expressed as the ratio of output power (i.e., Prect or the power delivered by the rectifier of the PRx) to input power (i.e., the input power or inverter power delivered by the inverter of the PTx). Thus, one device other the other may communicate its power level to the other for use in the efficiency determination.

In block 644, either device can determine whether a higher operating efficiency would be possible in the intermittent power profile mode. If not, then the system can continue operating with the present wireless power transfer profile (e.g., the Light Load Profile) in block 645. Otherwise, the system can switch to the intermittent power profile in block 646. As described above, the higher efficiency determination can be supplemented or replaced by other consideration, such as thermal load, operating frequency, etc. In any case, the foregoing operations contained within block 634 can be performed by the PRx, the PTx, or by the two devices acting in concert, such as by negotiating the power transfer profile. Regardless of which device(s) are performing the operations, communication between the devices may be employed as appropriate to provide data to inform the determinations, instruction to initiate a transfer, requests to initiate a transfer, acknowledgements of any of the foregoing, etc.

With the intermittent power profile initiated, the PTx can transmit power according to the intermittent profile (block 647) as described above. Correspondingly, the PRx can receive power (block 648). The receiver can also determine whether more or less power is required (block 649). If not, power transfer can continue. If less power is required, the wireless power receiver can determine whether the system is already operating at its minimum macro duty cycle (block 631a). If so, then the system can transition to another power profile, such as a light load profile (block 633a) as described above. Otherwise, the wireless power receiver can send a request to the PTx do decrease the macro duty cycle (block 632b), thereby reducing the power delivered to the PRx. If more power is required, the wireless power receiver can determine whether the system is already operating at its maximum macro duty cycle (block 631b). If so, then the system can transition to another power profile, such as a nominal power profile (block 633b) as described above. Otherwise, the wireless power receiver can send a request to the PTx do increase the macro duty cycle (block 632b), thereby increasing the power delivered to the PRx.

In some cases, the minimum duty cycle could be zero, corresponding to suspended or cloaked operation. In other cases, the minimum duty cycle could be some non-zero minimum value determined by any appropriate operating condition or constraint. Similarly, the maximum macro duty cycle could be 100%, corresponding to the nominal power profile as described above. In other cases, the maximum duty cycle could be some value less than 100% determined by any appropriate operating condition or constraint. Additionally, the operations inside block 635 could be performed by the PRx, the PTx, and/or by both devices acting in concert, such as by negotiation. If the PTx were to make the determination that a minimum or maximum macro duty cycle had been reached, then this could take place after the corresponding request was received from the PRx. Thus, the order of certain blocks illustrated in the flowchart of FIG. 6 could be different. In general, unless expressly required or necessitated by context, the various operations depicted could take place in a different order.

Preceding FIGS. 5 and 6 can be implemented jointly, such that the system can switch between three power profiles, such as an intermittent power profile as described herein and a light load profile (LPP) and/or a nominal power profile (NPP). The light load profile and/or the nominal power profile could also be omitted. In some embodiments, operation in only the intermittent power profile could be provided, with operation at a 100% macro duty cycle substituting for the nominal power profile described above.

Described above are various features and embodiments relating to wireless power transfer profiles to improve efficiency of wireless power transfer between a PTx and a PRx by using an intermittent power profile. Such arrangements may be used in a variety of applications but may be particularly advantageous when used in conjunction with electronic devices such as mobile phones, tablet computers, laptop or notebook computers, and accessories such as wireless headphones, styluses, smart watches, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices’ ability to provide wireless power signals to each other in an efficient manner to facilitate battery charging, such as by sharing of the devices’ power handling capabilities and/or by providing authentication information, such as prescribed by relevant wireless charging specifications, with one another. Entities implementing the present technology should take care to ensure that, to the extent any sensitive information is communicated between PTx and PRx devices in particular implementations, that well-established privacy policies and/or privacy practices are complied with.

In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A method of operating a wireless power transfer system including a wireless power transmitter and a wireless power receiver according to a plurality of wireless power transfer profiles, the plurality of wireless power transfer profiles including an intermittent power profile and at least one additional profile, the method comprising:
establishing wireless power transfer in accordance with the at least one additional profile;
determining by at least one of the wireless power transmitter or the wireless power receiver whether a higher efficiency of wireless power transfer is possible by operating according to the intermittent power profile; and
initiating by at least one of the wireless power transmitter or the wireless power receiver a transition to the intermittent power profile;
wherein the intermittent power profile comprises alternating the wireless power transfer system between an active state and a quiescent state according to a macro duty cycle representing a relationship between a duration of the active state and a duration of the quiescent state within a respective period of the macro duty cycle.

2. The method of claim 1 wherein determining whether a higher efficiency is possible by operating according to the intermittent power profile and initiating a transition to the intermittent power profile is requested by the wireless power receiver.

3. The method of claim 1 wherein the wireless power receiver requests an increase in the macro duty cycle responsive to a determination that more power is required and requests a decrease in the macro duty cycle responsive to a determination that less power is required.

4. The method of claim 1 wherein the at least one additional profile includes at least one of a Nominal Power Profile and a Light Load Profile defined by a Qi wireless power transfer standard.

5. The method of claim 4 wherein at least one of the wireless power transmitter or the wireless power receiver:
responsive to determining that the macro duty cycle is at a minimum macro duty cycle value, initiates a transition to a Light Load Profile defined by a Qi wireless power transfer standard; or
responsive to determining that the macro duty cycle is at a maximum macro duty cycle value, initiates a transition to a Nominal Power Profile defined by a Qi wireless power transfer standard.

6. The method of claim 1 further comprising determining whether the wireless power transfer system is operating at a predetermined frequency at which the intermittent power profile is permitted.

7. A wireless power receiver comprising:
a wireless power receiving coil magnetically couplable to a wireless power transmitting coil of a wireless power transmitter so as to allow the wireless power transmitting coil to transfer power to the wireless power receiver by inducing an alternating current in the wireless power receiving coil;
a rectifier coupled to the wireless power receiving coil that rectifies the alternating current induced in the wireless power receiving coil to produce a rectifier output voltage; and
wireless power receiver control circuitry coupled to the wireless power receiving coil and the rectifier that operates to vary the rectifier output voltage according to one or more wireless power transfer profiles;
wherein the one or more wireless power transfer profiles include an intermittent power profile in which the rectifier alternates between an active state and a quiescent state according to a macro duty cycle representing a relationship between a duration of the active state and a duration of the quiescent state within a respective period of the macro duty cycle.

8. The wireless power receiver of claim 7 wherein the wireless power receiver control circuitry alternates between the active state and the quiescent state according to the macro duty cycle.

9. The wireless power receiver of claim 7 wherein one or more wireless power transfer profiles include at least one additional profile selected from the group consisting of a Nominal Power Profile and a Light Load Profile defined by a Qi wireless power transfer standard.

10. The wireless power receiver of claim 7 wherein the wireless power receiver control circuitry selects the intermittent power profile responsive to a determination that a present power level can be delivered with higher efficiency operating according to the intermittent power profile.

11. The wireless power receiver of claim 10 wherein the determination that a present power level can be delivered with higher efficiency operating according to the intermittent power profile is made by the wireless power receiver control circuitry responsive to receiving an input power level from the wireless power transmitter.

12. The wireless power receiver of claim 10 wherein the determination that a present power level can be delivered with higher efficiency operating according to the intermittent power profile is made by the wireless power transmitter responsive to receiving an output power level from the wireless power receiver.

13. The wireless power receiver of claim 10 wherein the wireless power receiver control circuitry requests an increase in the macro duty cycle responsive to a determination that more power is required and requests a decrease in the macro duty cycle responsive to a determination that less power is required.

14. The wireless power receiver of claim 13 wherein at least one of the wireless power transmitter or the wireless power receiver:
responsive to determining that the macro duty cycle is at a minimum macro duty cycle value, initiates a transition to a Light Load Profile defined by a Qi wireless power transfer standard; or
responsive to determining that the macro duty cycle is at a maximum macro duty cycle value, initiates a transition to a Nominal Power Profile defined by a Qi wireless power transfer standard.

15. The wireless power receiver of claim 10 wherein the determination that a present power level can be delivered with higher efficiency operating according to the intermittent power profile is supplemented or replaced with a determination based on at least one of thermal conditions of the wireless power receiver or interoperability considerations.

16. A wireless power transmitter comprising:
a wireless power transmitting coil magnetically couplable to a wireless power receiving coil of a wireless power receiver so as to allow the wireless power transmitting coil to transfer power to the wireless power receiver by inducing an alternating current in the wireless power receiving coil;
an inverter coupled to the wireless power receiving coil that produces an alternating current induced in the wireless power receiving coil to allow a rectifier of the wireless power receiver to produce a rectifier output voltage; and
wireless power transmitter control circuitry coupled to the wireless power transmitting coil and the inverter that operates to allow the wireless power transmitter to vary the rectifier output voltage according to one or more wireless power transfer profiles;
wherein the one or more wireless power transfer profiles include an intermittent power profile in which the inverter alternates between an active state and a quiescent state according to a macro duty cycle representing a relationship between a duration of the active state and a duration of the quiescent state within a respective period of the macro duty cycle.

17. The wireless power transmitter of claim 16 wherein the wireless power transmitter control circuitry alternates between the active state and the quiescent state according to the macro duty cycle.

18. The wireless power transmitter of claim 16 wherein one or more wireless power transfer profiles include at least one additional profile selected from the group consisting of a Nominal Power Profile and a Light Load Profile defined by a Qi wireless power transfer standard.

19. The wireless power transmitter of claim 16 wherein the wireless power transmitter control circuitry selects the intermittent power profile responsive to a determination that a present power level can be delivered with higher efficiency operating according to the intermittent power profile.

20. The wireless power transmitter of claim 19 wherein the determination that a present power level can be delivered with higher efficiency operating according to the intermittent power profile is made by the wireless power receiver responsive to receiving an input power level from the wireless power transmitter.

21. The wireless power transmitter of claim 19 wherein the determination that a present power level can be delivered with higher efficiency operating according to the intermittent power profile is made by the wireless power transmitter control circuitry responsive to receiving an output power level from the wireless power receiver.

22. The wireless power transmitter of claim 19 wherein the wireless power transmitter control circuitry increases the macro duty cycle to increase power delivered to the wireless power receiver responsive to a request received from the wireless power receiver and decreases the macro duty cycle to decrease power delivered to the wireless power receiver responsive to a request received from the wireless power receiver.

23. The wireless power transmitter of claim 22 wherein at least one of the wireless power transmitter or the wireless power receiver:
responsive to determining that the macro duty cycle is at a minimum macro duty cycle value, initiates a transition to a Light Load Profile defined by a Qi wireless power transfer standard; or
responsive to determining that the macro duty cycle is at a maximum macro duty cycle value, initiates a transition to a Nominal Power Profile defined by a Qi wireless power transfer standard.

24. The wireless power transmitter of claim 19 wherein the determination that a present power level can be delivered with higher efficiency operating according to the intermittent power profile is supplemented or replaced with a determination based on at least one of thermal conditions of the wireless power receiver or interoperability considerations.
